(19) United States
(12) Patent Application Publication
(10) Pub. No.: US 2009/0163152 A1
(43) Pub. Date: Jun. 25, 2009

(54) Circuit board and power amplifier provided thereon

(76) Inventor: Mike Jiang, Chenghu (CN)

Correspondence Address: ERICSSON INC., 6300 LEGACY DRIVE, M/S EVR 1-C-11, PLANO, TX, 75024, US

(21) Appl. No.: 12/329,181

(22) Filed: Dec. 5, 2008

Related U.S. Application Data
(60) Provisional application No. 61/015,943, filed on Dec. 21, 2007.

(51) Int. Cl. H04B 1/38

(52) U.S. Cl. 455/90.2

(57) ABSTRACT

This description discloses a circuit board for a power amplifier that is able to keep a low temperature. In an example embodiment, the circuit board includes: an input board on its substrate, an output board on its substrate, and a power amplifier transistor acting as a bridge to connect the input board and the output board with each other. The substrate of the input board is made from a first kind of material, and the substrate of the output board is made from a second kind of material. The second kind of material has different performance (e.g., relatively better performance for both RF and heat dissipation) than that of the first kind of material. Moreover, this description discloses a power amplifier on the circuit board, a dual radio unit board having such a power amplifier, and a radio base station having such a dual radio unit board.

### CROSS-REFERENCE TO RELATED APPLICATION

This Nonprovisional U.S. patent application claims the benefit of U.S. Provisional Patent Application No. 61/015,943, filed 21 Dec. 2007, and entitled “Circuit board and power amplifier provided thereon, dual radio unit board, and radio base station”. U.S. Provisional Patent Application No. 61/015,943 is hereby incorporated by reference in its entirety herein.

### TECHNICAL FIELD

The present invention relates in general to a circuit board for a power amplifier that is able to keep a low temperature, a power amplifier on such a circuit board, a dual radio unit board comprising such a power amplifier, and a radio base station comprising such a dual radio unit board.

### BACKGROUND

The Radio Base Station (RBS) is widely used in a variety of mobile communication areas. A radio base station with high output power is expected for the purpose of increasing the servicing coverage. Meanwhile, the market requires such a radio base station to be more compact and of lower manufacturing cost. However, a high output power will result in a high temperature. High temperatures will increase power-consumption of the radio base station and shorten its service life or even destroy the circuit board of the power amplifier, so that the performance of the radio base station, especially that of the power amplifier, will be affected. Therefore, the heat dissipation for the power amplifier is important to keep at a low temperature for its normal performance.

In conventional designs for power amplifiers, HFFR4 (halogen free FR4 epoxy laminate) and R04350 (Rogers 4350) are the two kinds of popular materials used as the substrate of the power amplifier printed circuit board. The main differences between HFFR4 and R04350 are listed in Table 1:

TABLE 1
Performance comparison between HFFR4 and R04350.

| | Dielectric | Heat Dissipation | |
|---|---|---|---|
| Material | Loss Tangent | Performance | Cost |
| HFFR4 | 0.012 | Temperature (at the | 0.03 |
| | | interface between | RMB/cm² |
| | | substrate and PA | |
| | | transistor) = 135° C. | |
| | | (Output Power = 46.7 | |
| | | dBm) | |
| RO4350 | 0.004 | Temperature (at | 0.3 |
| | | interface between | RMB/cm² |
| | | substrate and PA | |
| | | transistor) = 84° C. | |
| | | (Output Power = 48.5 | |
| | | dBm) | |

FIG. 1 illustrates one known design of a DRU (Dual Radio Unit) board with a transceiver (TRX) board 1 and, separate from the transceiver board 1, a PA (power amplifier) board 3 having a power amplifier circuit comprising a PA transistor 5. Here, the whole substrate of the power amplifier circuit board 3 is made from R04350 in order to keep a low temperature for normal performance, which results in the following disadvantages:
1) The manufacturing cost for the power amplifier is high.
2) The integration level of the Dual Radio Unit (DRU) board, including the TRX (Transceiver) and power amplifier, is low.

The reasons are as follows:
the substrate of transceiver board 1 adopts HFFR4, which is different from the material used for the substrate of the power amplifier board 3. If R04350 is used as the substrate of the transceiver board 1, the manufacturing cost is high and micro-vias can not exist on the substrate (therefore pins of the digital components on the transceiver will interfere with each other).
between transceiver board 1 and the power amplifier board 3, there are many connectors and RF cables, which are collectively referred to with reference numeral 7 in FIG. 1, for transmitting signals. These cables and connectors 7 degrade the integration level of the dual radio unit board.
during the manufacturing procedure, great effort for assembling is needed between transceiver board 1 and power amplifier board 3.

### SUMMARY

A technical problem addressed by certain embodiments of this invention is to provide a circuit board for a power amplifier that is able to keep a low temperature with a relatively simple technical process and with low manufacturing costs. Furthermore, there may be provided a power amplifier on the circuit board, a dual radio unit board comprising such a power amplifier, and a radio base station comprising such a dual radio unit board.

This problem is at least ameliorated by the following example aspects of certain embodiments of the present invention:

A first example aspect of certain embodiments of the present invention relates to a circuit board for a power amplifier. The circuit board comprises an input board on its (first) substrate and an output board on its (second) substrate. The circuit board further comprises a power amplifier transistor acting as a bridge to connect the input board and the output board with each other. The first substrate of the input board is made from a first kind of material, and the second substrate of the output board is made from a second kind of material. Generally, the second kind of material has different performance than the first kind of material. For instance, the second kind of material may have relatively better performance for both RF and heat dissipation than that of the first kind of material.

A second example aspect of certain embodiments of the present invention relates to a power amplifier provided on the circuit board.

A third example aspect of certain embodiments of the present invention relates to a dual radio unit board comprising a transceiver and the power amplifier.

A fourth example aspect of certain embodiments of the present invention is related to a radio base station that comprises the dual radio unit board.

Some example advantages of certain embodiments of the invention are:
keeping a low temperature for normal performance of the power amplifier.
low manufacturing cost.
less space (e.g., of 30%) needed for the dual radio unit in comparison with the solution of the prior art.
less assembling work needed during the manufacturing procedure.

A person skilled in the art will appreciate that further objects and advantages may be associated with particular embodiments, examples of which are set out in the Detailed Description and the Drawings. It is to be understood that both the foregoing general description and the following Detailed Description are exemplary and explanatory only and are not restrictive of the invention as disclosed or as claimed.

### BRIEF DESCRIPTION OF THE DRAWINGS

FIG. 1 is a schematic block diagram of a dual radio unit of the prior art.

FIG. 2 is a schematic block diagram of an example dual radio unit according to an embodiment of the invention.

FIG. 3 is a schematic block diagram of an example radio base station with a dual radio unit according to an embodiment of the invention.

FIG. 4 is a top view of an example power amplifier circuit board according to an embodiment of the invention.

### DETAILED DESCRIPTION

FIG. 2 is a block diagram illustrating an example DRU board according to an embodiment of the invention. The DRU board comprises a TRX board 1.1 and a PA board, which is divided into two parts. One of the parts of the PA board serves as a PA input board 3a, and the other part serves as a PA output board 3b. A PA transistor 5 is arranged on the PA board such that an input of the PA transistor 5 is located on the input board 3a and such that an output of the PA transistor 5 is located on the output board 3b.

A (first) substrate of the input board 3a is made from a first kind of material, e.g. any common substrate material, for example, HFFR4. Because especially the output port of the PA can have a high temperature, the (second) substrate of the output board 3b is made from a second kind of material designed for RF (Radio Frequency) usage, for example, R04350. The second kind of material may also be any other substrate material selected from a group including: Rogers, Arlon, Taconic, Metclad, GIL etc., which have a low dielectric loss tangent and better heat dissipation, but typically higher manufacturing costs in comparison with the first kind of material.

The power generated at the input board 3a is not so relatively high, so the HFFR4 substrate (or similar) can meet the requirements for keeping a low temperature for normal performance without difficulty. However, the power generated on the output board 3b is higher, so the R04350 substrate (or other relatively higher-performance substrate material) is chosen to keep a low temperature for normal performance. The substrate of the input board 3a may be, for example, of the same material as the substrate of transceiver board 1.1, so that the input board 3a and the transceiver board 1.1 can share a monolithic substrate.

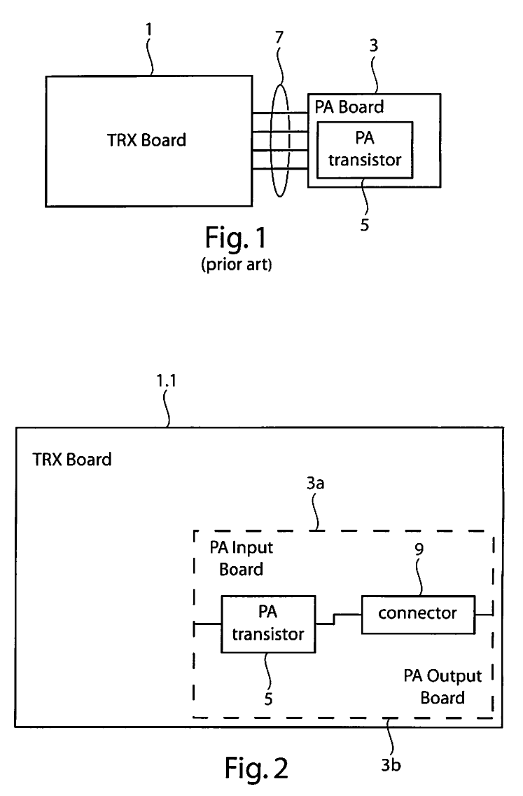

According to an exemplary embodiment, the output board 3b is fitted in a suitably-shaped space so that the output board 3b together with the input board 3a and the transceiver board 1.1 forms a rectangular circuit board, as illustrated in FIG. 2. Furthermore, a connector 9 may be provided on the PA board in order to create a connection between the input board 3a and the output board 3b. The connectors and RF cables 7 of the above-mentioned prior art solution (of FIG. 1) can thus be omitted. Consequently, an integration level of the dual radio unit of FIG. 2 can be increased in comparison with that of the solution in the above-mentioned prior art.

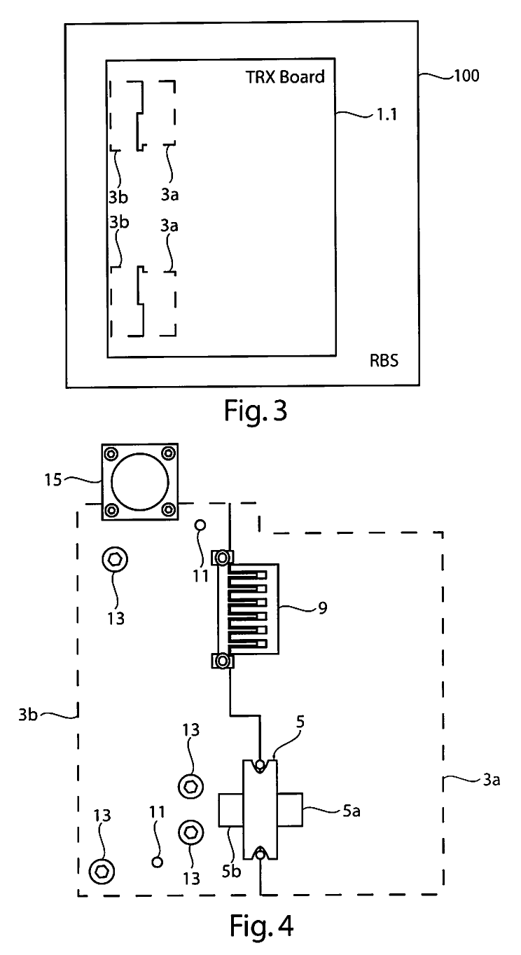

FIG. 3 is a relatively simple block diagram illustrating an example RBS 100 that is provided with a DRU with TRX board 1.1 and multiple input boards 3a and output boards 3b. Although other numbers may be implemented, in this exemplary embodiment, TRX board 1.1 includes two PA radio boards, each comprising an input board 3a and an output board 3b.

FIG. 4 is amore detailed top view of an example PA board in accordance with an embodiment of the invention. A person skilled in the art will, however, appreciate that the figure is simplified in that it does not show all components, conductors etc., so as to not obscure the presentation with well-known details of PA design. As before, the PA board includes an input board 3a with a first substrate made of a first kind of material, such as HFFR4, and an output board 3b with a second substrate made of a second kind of material, such as R04350 or any other kind of higher performance material, including the materials mentioned earlier.

An input terminal 5a of a PA transistor 5 is pressed on the first substrate of the input board 3a, and an output terminal 5b of PA transistor 5 is pressed on the second substrate of the output board 3b. A contact surface may be gold plated. Rubber may also be adopted as an interface between the first and second substrates and the PA transistor 5. In this way, if the first substrate of the input board 3a and the second substrate of the output board 3b are in misalignment, the PA transistor 5 can still work normally due to the flexibility of the rubber. Accordingly, a good connection of the PA transistor 5 on the different substrates is obtained for the PA circuit board.

In the example embodiment of FIG. 4, a connector 9 is provided in order to connect the first and second substrates of the input board 3a and the output board 3b, respectively, with each other. The connector 9 can be implemented as a conventional type of connector, e.g. in a way widely adopted in laptops or by means of any other known proper technique. The connector 9 may normally comprise two easily connectable parts, typically a male part and a corresponding female part. In an exemplary embodiment, there are preferably at least five pins in the male part. A first and a second pin supply power to a circuit on the output board 3a; a third pin is connected to ground; a fourth pin supplies a voltage of, for example, 5 v for operating the amplifier; and a fifth pin transmits a detector signal. In a particular embodiment, the male part is welded on the first substrate of the input board 3a, and the female part is welded on the second substrate of the output board 3b.

FIG. 4 also illustrates a preferable positioning of an isolator 15. The isolator 15 may be connected to the second substrate of the output board 3b by means of traditional welding, for example.

In a particular embodiment, the PA board of FIG. 4 may form part of a DRU with a TRX board 1.1 having a substrate that is also made of the above-mentioned first kind of material (e.g., HFFR4). Then the parts that use the first kind of material for their substrates can form a single board for the purpose of integration. A suitably-shaped space is left free for the second substrate of the output board 3b. However, for a high level of integration, the space left for the output board 3b substrate is straight, so the output board 3b substrate is positioned with relatively high precision. To facilitate the positioning of the output board 3b substrate, guiding pins 11, preferably two pins, are provided. The guiding pins 11 allow the output board 3b substrate to be easily positioned with high precision.

Furthermore, in the example embodiment of FIG. 4, a plurality of bolts 13, preferably four bolts, are provided. The bolts 13 fix the second substrate of the output board 3b onto a heat sink in order to “guarantee” efficient heat dissipation from the output board 3b.

The order, interconnections, interrelationships, layouts, etc. in which FIGS. 2-4 are described and/or shown are not intended to be construed as a limitation, and any number of the blocks and/or other elements may be modified, combined, rearranged, augmented, omitted, etc. in many manners when implementing a circuit board having a power amplifier disposed thereon. Accordingly, persons skilled in the art will appreciate that the present invention can be practiced by other than the described embodiments, which are presented for purpose of illustration rather than of limitation. Thus, although multiple embodiments of the present invention have been illustrated in the accompanying Drawings and described in the foregoing Detailed Description, it should be understood that the invention is not limited to the disclosed embodiments, for it is also capable of numerous rearrangements, modifications, and substitutions without departing from the scope of the invention as set forth and defined by the following claims.

What is claimed is:

1. A circuit board for a power amplifier, comprising:
an input board on a substrate made from a first kind of material;
an output board on a substrate made from a second kind of material, the second kind of material having different performance than the first kind of material; and
a power amplifier transistor acting as a bridge to connect the input board and the output board with each other.

2. The circuit board for a power amplifier according to claim 1, wherein the second kind of material has better radio frequency (RF) performance than the first kind of material.

3. The circuit board for a power amplifier according to claim 1, wherein the second kind of material has better heat dissipation performance than the first kind of material.

4. The circuit board for a power amplifier according to claim 1, wherein the second kind of material has a lower dielectric loss tangent.

5. The circuit board for a power amplifier according to claim 1, wherein the second kind of material has better performance for both radio frequency (RF) and heat dissipation than does the first kind of material.

6. The circuit board for a power amplifier according to claim 1, wherein the first kind of material is halogen free FR4 epoxy laminate and the second kind of material is Rogers 4350.

7. The circuit board for a power amplifier according to claim 1, wherein the power amplifier transistor comprises an input terminal pressed on the substrate of the input board and an output terminal pressed on the substrate of the output board.

8. The circuit board for a power amplifier according to claim 1, wherein the circuit board further comprises a connector arranged on the circuit board for connecting the substrate of the input board with the substrate of the output board.

9. The circuit board for a power amplifier according to claim 1, wherein an isolator is connected to the substrate of the output board by welding.

10. The circuit board for a power amplifier according to claim 1, wherein a plurality of bolts are arranged to fix the substrate of the output board onto a heat sink, whereby further improving heat dissipation from the output board.

11. The circuit board for a power amplifier according to claim 1, wherein a power amplifier is provided on the circuit board.

12. A dual radio unit board, comprising:
a transceiver board including a transceiver;
a power amplifier board including:
an input board on a substrate made from a first kind of material;
an output board on a substrate made from a second kind of material, the second kind of material having different performance than the first kind of material; and
a power amplifier transistor acting as a bridge to connect the input board and the output board with each other.

13. The dual radio unit board according to claim 12, wherein a power amplifier is provided on the power amplifier board.

14. The dual radio unit board according to claim 12, wherein the substrate of the input board for the power amplifier board and a substrate of the transceiver board form the same substrate.

15. The dual radio unit board according to claim 12, wherein a plurality of guiding pins is provided to facilitate positioning of the output board with regard to the input board.

16. The dual radio unit board according to claim 12, wherein the second kind of material has better performance for radio frequency (RF) or heat dissipation than does the first kind of material.

17. A radio base station, comprising:
a radio unit board that comprises:
a transceiver board including a transceiver; and
a power amplifier board including:
an input board on a substrate made from a first kind of material;
an output board on a substrate made from a second kind of material, the second kind of material having different performance than the first kind of material; and
a power amplifier transistor acting as a bridge to connect the input board and the output board with each other.

18. The radio base station according to claim 17, wherein the input board and the transceiver board share a monolithic substrate.

19. The radio base station according to claim 17, wherein the second kind of material has better performance for radio frequency (RF) or heat dissipation than does the first kind of material.

20. The radio base station according to claim 17, wherein the output board is fitted in a suitably-shaped space so that the output board together with the input board and the transceiver board form a rectangular circuit board.
